(19) United States
(12) Patent Application Publication
(10) Pub. No.: US 2021/0327667 A1
(43) Pub. Date: Oct. 21, 2021

(54) SENSOR SWITCH

(71) Applicant: Tien-Ming CHOU, Taichung City (TW)

(72) Inventor: Tien-Ming CHOU, Taichung City (TW)

(21) Appl. No.: 17/087,017

(22) Filed: Nov. 2, 2020

(30) Foreign Application Priority Data
Apr. 17, 2020 (TW) 109113063

(51) Int. Cl. H01H 35/02; H01H 1/16; H01H 9/54; H01H 11/04; H01H 1/58

(52) U.S. Cl. CPC H01H 35/02; H01H 1/16; H01H 1/5833; H01H 11/045; H01H 9/54

(57) ABSTRACT

A sensor switch includes a ceramic body including an intermediate layer assembly having an inner peripheral surface with a through hole, a first side layer assembly having a first groove, and a second side layer assembly having a second groove. A first conductive layer is disposed in the first groove, and has a first contact surface. A second conductive layer is disposed in the second groove, and has a second contact surface. The inner peripheral surface and the first and second contact surfaces cooperatively define a sensing cavity. A conductive member is rollably disposed in the sensing cavity and is movable between closed and open circuit positions to achieve a sensing effect.

### CROSS REFERENCE TO RELATED APPLICATION

This application claims priority of Taiwanese Patent Application Number 109113063, filed on Apr. 17, 2020.

### FIELD

The disclosure relates to a switch device, more particularly to a sensor switch.

### BACKGROUND

An existing rolling ball sensor switch is configured to be disposed on a circuit board, and uses a rolling ball therein to sense the angle change and then transmit the sensed result to the circuit board. Thus, the rolling ball sensor switch can be used in security alarm devices, anti-theft devices, toys, etc. However, the existing sensor switch is composed of a non-conductive shell and two electrodes that form a package, and a conductive member is encapsulated in an internal cavity of the package. The tight connection between the non-conductive shell and the electrodes can be strengthen through an engaging structure or fixing elements, as disclosed in Japanese Publication No. 2003-161653, so that the volume of the existing sensor switch is limited and cannot be reduced.

### SUMMARY

Therefore, an object of the present disclosure is to provide a sensor switch that can alleviate at least one of the drawbacks of the prior art.

According to this disclosure, a sensor switch comprises a ceramic body, first and second conductive units, and a conductive member.

The ceramic body is made from a plurality of raw ceramic blanks that are sintered after being stacked, and includes an intermediate layer assembly having an intermediate layer inner peripheral surface that defines a through hole, a first side layer assembly disposed on one side of the intermediate layer assembly and closing one end of the through hole, and a second side layer assembly disposed on the other side of the intermediate layer assembly and closing the other end of the through hole. The first side layer assembly has a first groove opening toward the through hole and communicating with the through hole, and a first side layer outer peripheral surface. The second side layer assembly has a second groove opening toward the through hole and communicating with the through hole, and a second side layer outer peripheral surface.

The first conductive unit is made of metal and includes a first conductive layer disposed in the first groove and having a first contact surface facing the through hole, and at least one first internal circuit connected to the first conductive layer and extending from the first conductive layer to the first side layer outer peripheral surface. The second conductive unit is made of metal and includes a second conductive layer disposed in the second groove and having a second contact surface facing the through hole, and at least one second internal circuit connected to the second conductive layer and extending from the second conductive layer to the second side layer outer peripheral surface. The intermediate layer inner peripheral surface, the first contact surface and the second contact surface cooperatively define a sensing cavity.

The conductive member is rollably disposed in the sensing cavity and is movable between a closed circuit position and an open circuit position. When the conductive member is in the closed circuit position, the first conductive layer, the first contact surface and the second contact surface form a current path; and when the conductive member is in the open circuit position, the conductive member, the first contact surface and the second contact surface do not form a current path.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of a sensor switch according to an embodiment of the present disclosure;

FIG. 2 is a schematic front view of the embodiment;

FIG. 3 is a sectional view of the embodiment taken along line III-III of FIG. 2;

FIG. 4 is a sectional view of the embodiment taken along line IV-IV of FIG. 2;

FIG. 5 is a sectional view of the embodiment taken along line V-V of FIG. 2;

FIG. 6 is an exploded perspective view of the embodiment.

### DETAILED DESCRIPTION

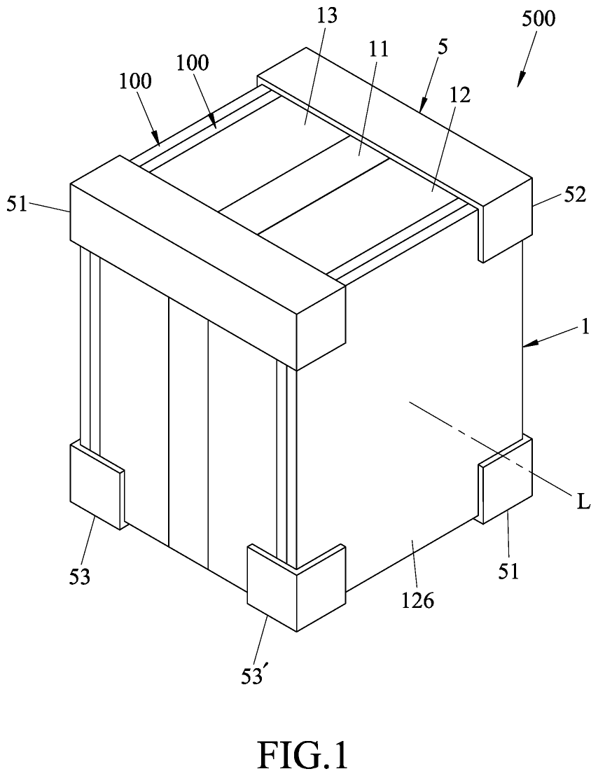

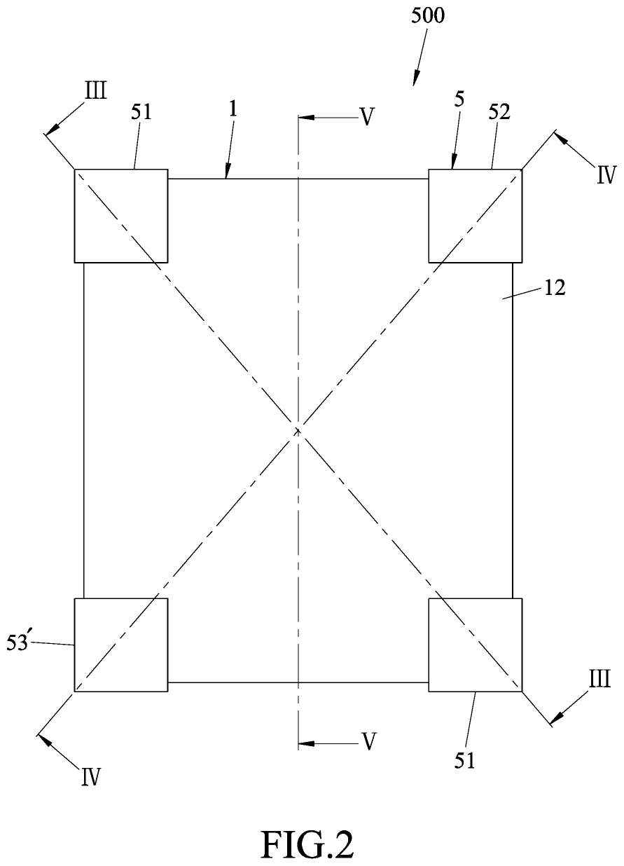

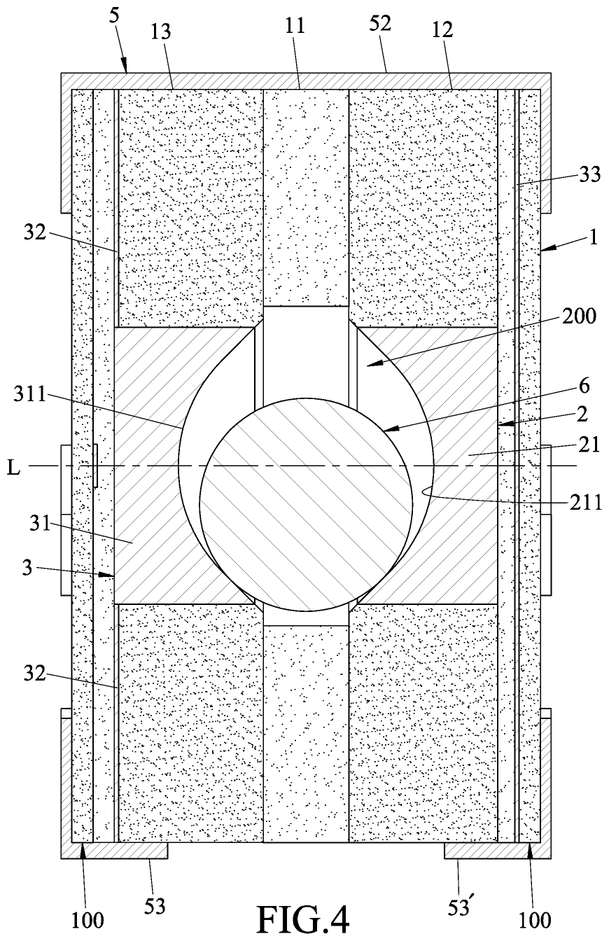

Referring to FIGS. 1 to 6, a sensor switch 500 according to an embodiment of the present disclosure includes a ceramic body 1, a first conductive unit 2, a second conductive unit 3, an external electrode unit 5, and a conductive member 6.

The ceramic body 1 is made from a plurality of raw ceramic blanks 100 that are sintered after being stacked. The ceramic body 1 has a rectangular shape, and includes an intermediate layer assembly 11 having an intermediate layer inner peripheral surface 111 that defines a through hole 110, a first side layer assembly 12 disposed on one side of the intermediate layer assembly 11 and closing one end of the through hole 110, and a second side layer assembly 13 disposed on another side of the intermediate layer assembly 11 and closing the other end of the through hole 110. The first side layer assembly 12, the intermediate layer assembly 11 and the second side layer assembly 13 are arranged in a front-to-rear direction, as shown in FIG. 1.

The first side layer assembly 12 has a first side layer connecting surface 122 connected to the one side of the intermediate layer assembly 11, a first groove 121 indented inwardly from the first side layer connecting surface 122, a first side layer outer surface 126 opposite to the first groove 121, and a first side layer outer peripheral surface 125 connected between outer peripheries of the first side layer connecting surface 122 and the first side layer outer surface 126. The first groove 121 opens toward the through hole 110, and communicates with the same. Further, the first groove 121 is defined by a groove surrounding wall 123 connected to the first side layer connecting surface 122, and a groove bottom wall 124 connected to the groove surrounding wall 123 opposite the first side layer connecting surface 122.

The second side layer assembly 13 has a second side layer connecting surface 132 connected to the another side of the intermediate layer assembly 11, a second groove 131 indented inwardly from the second side layer connecting surface 132, a second side layer outer surface 136 opposite to the second groove 131, and a second side layer outer peripheral surface 135 connected between outer peripheries of the second side layer connecting surface 132 and the second side layer outer surface 136. The second groove 131 opens toward the through hole 110, and communicates with the same. Further, the second groove 131 is defined by a groove surrounding wall 133 connected to the second side layer connecting surface 132, and a groove bottom wall 134 connected to the groove surrounding wall 133 opposite the second side layer connecting surface 132.

In this embodiment, each of the first and second side layer assemblies 12, 13 includes three raw ceramic blanks 100, while the intermediate layer assembly 11 includes only one raw ceramic blank 100. However, the number of the raw ceramic blanks 100 in each of the first side layer assembly 12, the intermediate layer assembly 11 and the second side layer assembly 13 is not limited to what is disclosed herein. A first raw ceramic blank 100 of the first side layer assembly 12 has the first side layer connecting surface 122, and a first raw ceramic blank 100 of the second side layer assembly 13 has the second side layer connecting surface 132.

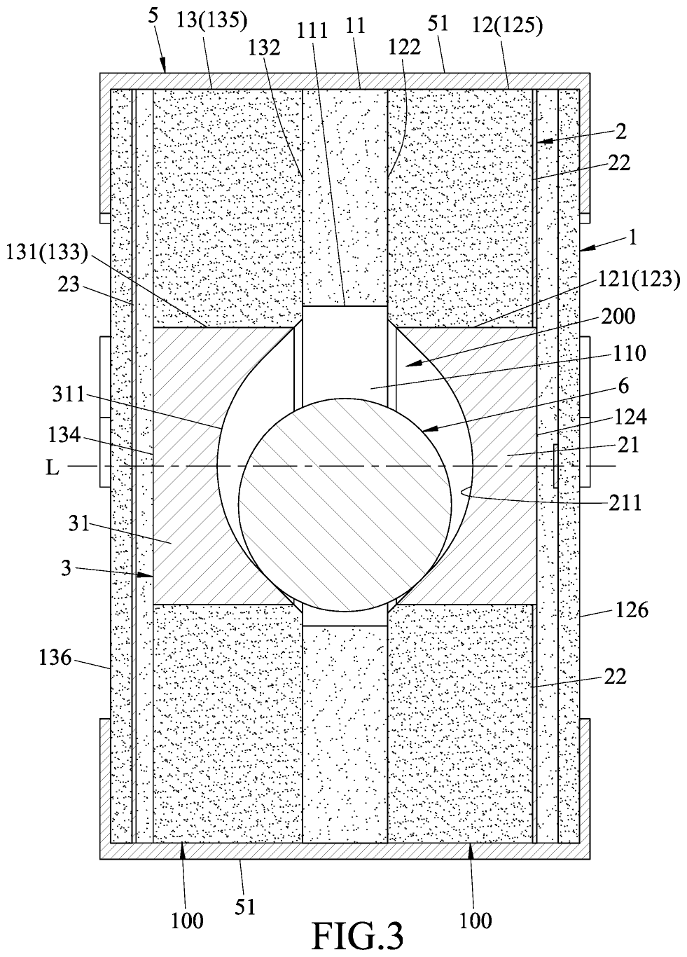

With reference to FIGS. 3, 4 and 6, the first conductive unit 2 is made of metal, and includes a first conductive layer 21, at least one first internal circuit 22, and a first series connection circuit 23. The first conductive layer 21 is disposed in the first groove 121, and has a first contact surface 211 facing the through hole 110. In this embodiment, the first conductive unit 2 includes two first internal circuits 22. The first internal circuits 22 are embedded between the first and second raw ceramic blanks 100 of the first side layer assembly 12, are connected to the first conductive layer 21 at the groove bottom wall 124, and extend radially from the first conductive layer 21 to the first side layer outer peripheral surface 125. Specifically, the first internal circuits 22 are diagonally opposite to each other. The first series connection circuit 23 is embedded between second and third raw ceramic blanks 100 of the second side layer assembly 13, and extends in a direction similar to that of the first internal circuits 22.

The second conductive unit 3 is made of metal, and includes a second conductive layer 31, at least one second internal circuit 32, and a second series connection circuit 33. The second conductive layer 31 is disposed in the second groove 131, and has a second contact surface 311 facing the through hole 110. In this embodiment, the second conductive unit 3 includes two second internal circuits 32. The second internal circuits 32 are embedded between the first and second raw ceramic blanks 100 of the second side layer assembly 13, are connected to the second conductive layer 31 at the groove bottom wall 134, and extend radially from the second conductive layer 31 to the second side layer outer peripheral surface 135. Specifically, the second internal circuits 32 are diagonally opposite to each other. The second series connection circuit 33 is embedded between second and third raw ceramic blanks 100 of the first side layer assembly 12, and extends in a direction similar to that of the second internal circuits 32, but different from that of the first internal circuits 22.

The intermediate layer inner peripheral surface 111, the first contact surface 211 and the second contact surface 311 cooperatively define a sensing cavity 200 having an axis (L) parallel to the front-to-rear direction. In this embodiment, each of the first and second contact surfaces 211, 311 has a curved shape that curves away from the through hole 110. That is, the first and second contact surfaces 211, 212 are concave and face each other, as shown in FIG. 3.

With reference to FIGS. 1, 3, 4 and 6, the external electrode unit 5 is disposed on an outer surface of the ceramic body 1, and includes two first external electrodes 51, a second external electrode 52, and two third external electrodes 53, 53′. Each of the first external electrodes 51 has an elongated cubic shape, and extends along one side of the ceramic body 1 from the first side layer outer surface 126 to the second side layer outer surface 136. The first external electrodes 51 are diagonally opposite to each other, and are connected to the first internal circuits 22 and the first series connection circuit 23. The second external electrode 52 also has an elongated cubic shape, extends along another side of the ceramic body 1 from the first side layer outer surface 126 to the second side layer outer surface 136, is located between the first external electrodes 51, and is connected to the second series connection circuit 33 and one of the second internal circuits 32. The third external electrodes 53, 53′ are spacedly disposed on yet another side of the ceramic body 1, and are diagonally opposite to the second external electrode 52. Each of the third external electrodes 53, 53′ has a cubic shape. The third external electrode 53 is connected to the other one of the second internal circuits 32, while the third external electrode 53′ is connected to the second series connection circuit 33 opposite the second external electrode 52. In this embodiment, the first, second and third external electrodes 51, 52, 53, 53′ are disposed on corners of the ceramic body 1, as best shown in FIG. 1.

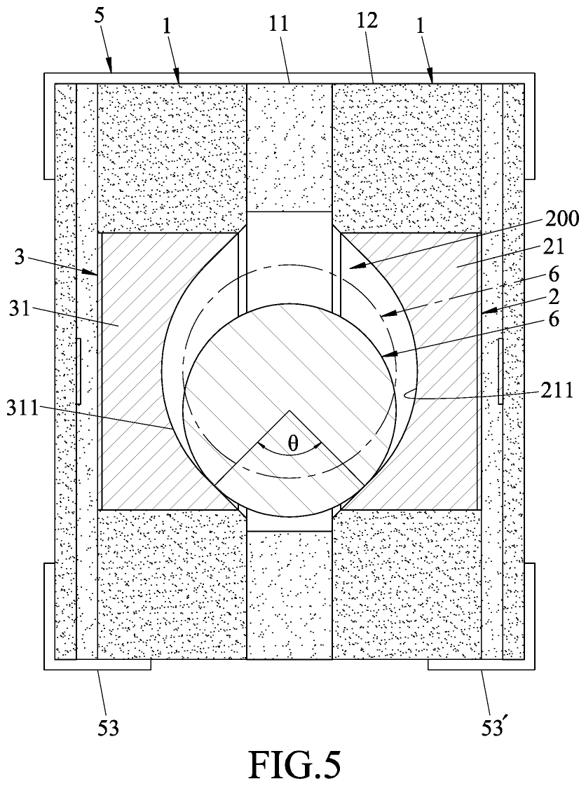

The conductive member 6 is rollably disposed in the sensing cavity 200, and is movable between a closed circuit position and an open circuit position. When the conductive member 6 is in the closed circuit position, as shown in solid line in FIG. 5, the conductive member 6 is simultaneously in contact with the first contact surface 211 and the second contact surface 311 to form a current path. When the conductive member 6 is in the open circuit position, the conductive member 6 is not in contact with one or both of the first and second contact surfaces 211, 311, as shown in imaginary line in FIG. 5, so as not to form a current path.

In this embodiment, the conductive member 6 has a spherical shape. When the conductive member 6 simultaneously contacts the first and second contact surfaces 211, 311, the center of the conductive member 6, a line of contact between the center of the conductive member 6 and the first contact surface 211, and a line of contact between the center of the conductive member 6 and the second contact surface 311 form an included angle of θ therebetween on a vertical section passing through the center of the conductive member 6, and 80°<θ<100°. In this embodiment, the included angle (θ) is 90°.

To use the sensor switch 500, the sensor switch 500 is first soldered to a circuit board (not shown) using the first to third external electrodes 51, 52, 53, 53′. Through the disposition of the first to third external electrodes 51, 52, 53, 53′, the sensor switch 500 can be soldered to the circuit board in different directions according to the requirements of a user or a manufacturer.

In use, when the ceramic body 1 is placed such that the axis (L) is in a horizontal position, the conductive member 6 is located in the closed circuit position (see the solid line in FIG. 5), and is simultaneously in contact with the first and second contact surfaces 211, 311 to form a current path. When the ceramic body 1 is vibrated such that the conductive member 6 moves away from one or both of the first and second contact surfaces 211, 311, the conductive member 6 is shifted to the open circuit position (see the imaginary line in FIG. 5), and does not form a current path with the first and second contact surfaces 211, 311.

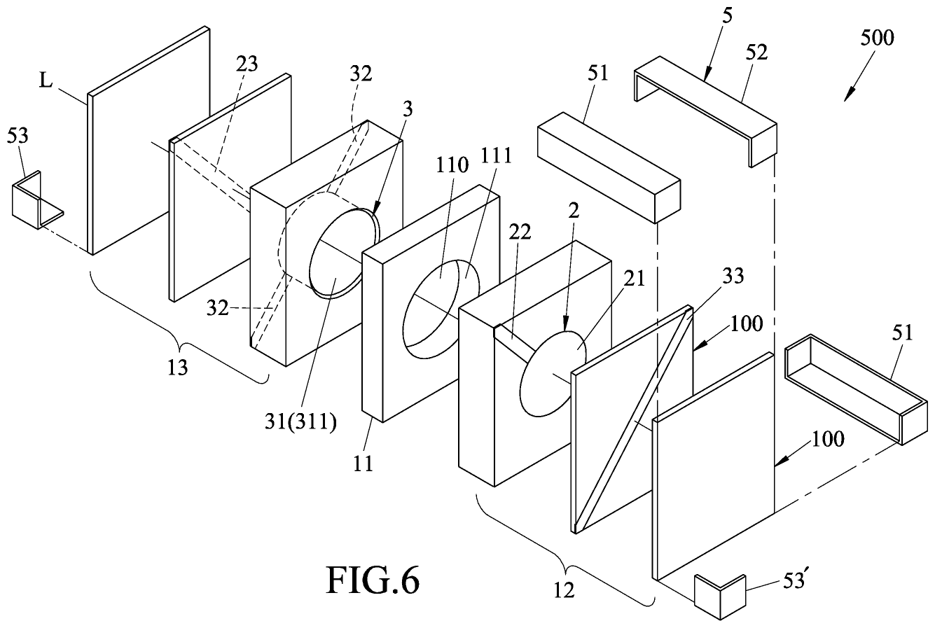

With reference to FIG. 6, it should be noted that this embodiment is made by multilayer ceramics (MLC) technology. A manufacturing process of the sensor switch 500 of this embodiment involves the following steps:

Step 1: preparing a plurality of raw ceramic blanks 100 made from inorganic ceramic materials and forming holes in the raw ceramic blanks 100 by machining;

Step 2: disposing metal materials, such as silver, gold, palladium, copper, nickel, or alloys thereof, on corresponding surfaces of the raw ceramic blanks 100 by applying conductive adhesive to a stencil, a steel plate, or an ink jet, or by alternately using electroplating, chemical plating, or sputtering so as to form the first and second conductive units 2, 3;

Step 3: stacking three raw ceramic blanks 100 along the axis (L) to form the first side layer assembly 12, stacking another three raw ceramic blanks 100 along the axis (L) to form the second side layer assembly 13, and connecting one raw ceramic blank 100 which forms the intermediate layer assembly 11 to the first side layer assembly 12 (or the second side layer assembly 13);

Step 4: hot pressing the intermediate layer assembly 11 and the first side layer assembly 12 (or the second side layer assembly 13) to form an integral body, and hot pressing the second side layer assembly 13 (or the first side layer assembly 12);

Step 5: cutting the stacked intermediate and first side layer assemblies 11, 12 to a desired size, and cutting the second side layer assembly 13 to a size similar to that of the stacked intermediate and first side layer assemblies 11, 12;

Step 6: disposing metal materials, such as gold, alloy, etc., by electroplating, sputtering or coating on corresponding surfaces of the first and second conductive units 2, 3;

Step 7: raising the ambient temperature at a slow heating rate to heat the raw ceramic blanks 100 after being cut and to burn and crack the polymer additives added to the raw ceramic blanks 100 during pulping so as to densify the raw ceramic blanks 100 and remove holes, and sintering the raw ceramic blanks 100 to form the stacked intermediate and first side layer assemblies 11, 12 into one body and the second side layer assembly 13 into another body;

Step 8: placing the conductive member 6 in the sensing cavity 200 defined by the stacked intermediate and first side layer assemblies 11, 12, then coating an adhesive material, such as resin, glass, etc., on a junction of the second side layer assembly 13 and the intermediate layer assembly 11, and irradiating or baking with UV light to raise the ambient temperature to below 500° C. to cure the adhesive material, thereby adhering integrally the second side layer assembly 13 to the intermediate layer assembly 11 to form the ceramic body 1; and

Step 9: disposing metal materials, such as silver, gold, palladium, copper, nickel, or other alloys, by electroplating, sputtering or coating on an outer surface of the ceramic body 1 to form the first to third external electrodes 51, 52, 53, 53′ of the external electrode unit 5, the first to third external electrodes 51, 52, 53, 53′ being densified to have good conductivity.

Moreover, after step 2, the raw ceramic blanks 100 with the disposed metal materials may first be bonded together to form a block or plural blocks, after which the sintering step is employed to form the block or plural blocks, followed by coating adhesive materials on the blocks. After heat treatment, they are formed into the ceramic body 1. The making of the ceramic body 1 is not limited to the aforesaid steps.

Additionally, the order of the steps of the manufacturing process of the sensor switch 500 may be changed according to the requirements, or may be replaced with other manufacturing method, and is not limited to what is disclosed herein.

In summary, through the ceramic body 1 which is made from a plurality of raw ceramic blanks 100 that are sintered after being stacked, and with the first and second conductive units 2, 3 being made of metal materials disposed on the raw ceramic blanks 100, the overall volume of the sensor switch 500 can break through the minimum volume limit of the traditional switch made of plastic, can obtain a more streamlined structure and a smaller volume, and can achieve a good sealing effect, so that the first to third conductive units 2, 3, 4 cannot be easily damaged by moisture. Therefore, the object of this disclosure can indeed be achieved.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A sensor switch comprising:
a ceramic body made from a plurality of raw ceramic blanks that are sintered after being stacked, said ceramic body including an intermediate layer assembly having an intermediate layer inner peripheral surface that defines a through hole, a first side layer assembly disposed on one side of said intermediate layer assembly and closing one end of said through hole, and a second side layer assembly disposed on the other side of said intermediate layer assembly and closing the other end of said through hole, said first side layer assembly having a first groove that opens toward said through hole and that communicates with said through hole, and a first side layer outer peripheral surface, said second side layer assembly having a second groove that opens toward said through hole and that communicates with said through hole, and a second side layer outer peripheral surface; and
a first conductive unit made of metal and including a first conductive layer disposed in said first groove and having a first contact surface facing said through hole, and at least one first internal circuit connected to said first conductive layer and extending from said first conductive layer to said first side layer outer peripheral surface;
a second conductive unit made of metal and including a second conductive layer disposed in said second groove and having a second contact surface facing said through hole, and at least one second internal circuit connected to said second conductive layer and extending from said second conductive layer to said second side layer outer peripheral surface;
said intermediate layer inner peripheral surface, said first contact surface and said second contact surface cooperatively defining a sensing cavity; and
a conductive member rollably disposed in said sensing cavity and movable between a closed circuit position and an open circuit position;
when said conductive member is in the closed circuit position, said conductive member is simultaneously in contact with said first contact surface and said second contact surface to form a current path; and
when said conductive member is in the open circuit position, said conductive member is not in contact with one or both of said first contact surface and said second contact surface so as not to form a current path.

2. The sensor switch as claimed in claim 1, wherein said at least one first internal circuit is connected to said first conductive layer at a groove bottom wall of said first groove, and said at least one second internal circuit is connected to said second conductive layer at a groove bottom wall of said second groove.

3. The sensor switch as claimed in claim 1, wherein said first side layer assembly, said intermediate layer assembly and said second side layer assembly are arranged along an axis.

4. The sensor switch as claimed in claim 3, wherein each of said first side layer assembly and said second side layer assembly includes a plurality of said raw ceramic blanks, said at least one first internal circuit being disposed on one of said raw ceramic blanks of said first side layer assembly and extending radially relative to the axis, said at least one second internal circuit being disposed on one of said raw ceramic blanks of said second side layer assembly and extending radially relative to the axis.

5. The sensor switch as claimed in claim 1, wherein each of said first contact surface and said second contact surface has a curved shape that curves away from said through hole.

6. The sensor switch as claimed in claim 5, wherein said conductive member has a spherical shape, and wherein, when said conductive member simultaneously contacts said first contact surface and said second contact surface, the center of said conductive member, a line of contact between the center of said conductive member and said first contact surface, and a line of contact between the center of said conductive member and said second contact surface form an included angle of θ therebetween on a vertical section passing through the center of said conductive member, and 80°<θ<100°.

7. The sensor switch as claimed in claim 1, wherein said first conductive unit and said second conductive unit are made by disposing metal materials on corresponding surfaces of said raw ceramic blanks by applying conductive adhesive to a stencil, a steel plate, or an ink jet, or by alternately using electroplating, chemical plating, or sputtering.

8. The sensor switch as claimed in claim 1, wherein said first side layer assembly further has a first side layer outer surface opposite to said first groove, said second side layer assembly further having a second side layer outer surface opposite to said second groove, said ceramic body having a rectangular shape, said sensor switch further comprising an external electrode unit disposed on an outer surface of said ceramic body, said external electrode unit including at least one first external electrode connected to said at least one first internal circuit, and at least one second external electrode connected to said at least one second internal circuit, said at least one first external electrode extending along one side of said ceramic body from said first side layer outer surface to said second side layer outer surface, said at least one second external electrode extending along another side of said ceramic body from said first side layer outer surface to said second side layer outer surface, and being proximate to said at least one first external electrode.
